(19) United States
(12) Patent Application Publication
(10) Pub. No.: US 2024/0403701 A1
(43) Pub. Date: Dec. 5, 2024

(54) COMPUTATION-EFFICIENT FEDERATED LEARNING FOR SYSTEMS WITH RESOURCE HETEROGENEITY

(71) Applicant: INTERNATIONAL BUSINESS MACHINES CORPORATION, ARMONK, NY (US)

(72) Inventors: Fatih Ilhan, Atlanta, GA (US); Gong Su, New York, NY (US)

(21) Appl. No.: 18/328,733

(22) Filed: Jun. 3, 2023

(51) Int. Cl. G06N 20/00

(52) U.S. Cl. CPC G06N 20/00

(57) ABSTRACT

A computer-implemented method for training a global model on a central server in a federated learning system comprised of a plurality of nodes includes splitting the global model along a width and a depth via two-dimensional uniform downscaling of the global model. A plurality of local models are created based on the splitting of the global model. Selected ones of the plurality of local models are trained on respective selected ones of a plurality of clients based on computational constraints of each of the plurality of clients.

### BACKGROUND

### Technical Field

The present disclosure generally relates to federated learning systems, and more particularly, to a computer-implemented method, a computer system, and a computer program product for computation-efficient federated learning that can handle system heterogeneity by using early exits, two-dimensional model downscaling and optimization with self-distillation.

### Description of the Related Art

Federated learning (FL) enables training a deep learning model across multiple clients, such as internet of things (IoT) devices, security cameras, laptops, smartphones, data centers, and the like, with decentralized data. With typical federated learning architectures, at each round, a global model is distributed to clients for local training and the central server aggregates the local updates received from each client. In most FL architectures, all clients are assumed to have similar computational capabilities and be able to finetune/train the global model.

### SUMMARY

In one embodiment, a system and method are provided that can provide computationally overhead-adjusted models to clients and can perform self-distillation on the client side, protecting data and reducing network traffic involved for the training of FL models across various clients.

In one embodiment, a computer-implemented method for training a global model on a central server in a federated learning system comprised of a plurality of nodes includes splitting the global model along a width and a depth via two-dimensional uniform downscaling of the global model. A plurality of local models can be created based on the splitting of the global model. Selected ones of the plurality of local models can be trained on respective selected ones of a plurality of clients based on computational constraints of each of the plurality of clients.

In some embodiments, the method further includes receiving, at the central server, local model parameters from each of the plurality of clients. In some embodiments, the method further includes aggregating, at the central server, the local model parameters across the plurality of clients into global model parameters and sending the global model parameters to each of the plurality of clients to update respective local models at each of the plurality of clients.

In some embodiments, the method further includes waiting, by the central server, until the aggregated local model parameters are received from all of the plurality of clients before updating the global model parameters.

In some embodiments, the method further includes obtaining a number of complexity levels for the federated learning system and a target computational overhead reduction ratio for each of the complexity levels. A computational overhead of each of the plurality of local models at each of the complexity levels can then be computed.

In some embodiments, the method further includes determining early exits of the global model to generate a local model for each of the complexity levels.

In another embodiment, a computer-implemented method for training a global model on a central server in a federated learning system having a plurality of nodes includes obtaining a number of complexity levels for the federated learning system and a target computational overhead reduction ratio for each of the complexity levels. The global model can be split along a width and a depth via two-dimensional uniform downscaling of the global model to create a plurality of local models, wherein one of the plurality of local models corresponds to each of the number of complexity levels. A computational overhead of each of a plurality of local models at each of the complexity levels can be computed and an assigned one of the plurality of local models can be sent to each of a plurality of clients based on an available computational overhead budget at each of the plurality of clients, wherein the computational overhead of the assigned one is less than the available computational overhead budget at each of the plurality of clients. The assigned ones of the plurality of local models can be trained on respective ones of the plurality of clients.

The above method can be performed on non-transitory computer readable storage medium tangibly embodying a computer readable program code having computer readable instructions that, when executed, causes a computer device to provide computation-efficient federated learning that can handle system heterogeneity by using early exits, two-dimensional model downscaling and optimization with self-distillation.

By virtue of the concepts discussed herein, systems and methods are provided for providing computation-efficient federated learning that can handle system heterogeneity by using early exits, two-dimensional model downscaling and optimization with self-distillation. As discussed in greater detail below, such a system and method can reduce computational overhead/complexity by providing scaled models for different clients depending on the computational resources of the various clients.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a system architecture for federated learning with three levels, where, given constraint configuration, a split ratio can be computed and early exit classifiers can be provided for a given model, and local models are trained using a combination of cross-entropy and KL-divergence losses, consistent with an illustrative embodiment;

FIGS. 2A through 2C show subnetwork structures for local models at levels 1, 2 and L, respectively, consistent with an illustrative embodiment;

FIGS. 3A and 3B show a flow chart describing a method of federated learning, consistent with an illustrative embodiment;

FIGS. 4A and 4B show local performance analysis of the federated learning process of the present disclosure as compared to conventional federated learning processes on a first dataset;

FIGS. 5A and 5B show local performance analysis of the federated learning process of the present disclosure as compared to conventional federated learning processes on a second dataset; and

FIG. 6 is a functional block diagram illustration of a computer hardware platform that can be used to implement the method for federated learning, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

Broadly, aspects of the present disclosure provide systems and methods that provide an improved FL framework. As described in greater detail below, the systems and methods can provide efficient small subnetworks for constrained clients via two-dimensional uniform downscaling through model splitting along a width (hidden size) and a depth (number of layers) using early exits. Resulting local models provide the best balance between preserving low-level basic and high-level complex feature extraction capabilities. Local models at lower complexity levels preserve high performance for constrained clients during inference. Early exits bring the adaptive inference capability if inference-time constraints are dynamic. The systems and methods provide local optimization with self-distillation over early exit predictions (early exits as students and final exit as teacher) to improve the knowledge transfer among subnetworks within the global model. With the systems and methods described herein, neither additional training on clients or the central server over shared data nor sharing of the intermediate layer outputs are required.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide federated learning systems and methods that can provide efficient small subnetworks for constrained clients via two-dimensional uniform downscaling through model splitting along a width (hidden size) and a depth (number of layers) using early exits. This may have the technical effect of permitting clients with limited computing resources to use a consolidated model, or an early exit therefrom, for their local data, thus providing a model that can be executed on the client while not requiring additional computing resources beyond those dedicated to the model by the client.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

### Framework

A training dataset can have N sets of input and target pairs [symbol] ={(Xᵢ, yᵢ)}ᵢ₌₁^{N} distributed to K clients with { [symbol] ₖ}ₖ₌₁^{K} (the set of data indices at each client). A goal is training a model in a scenario where clients can have different computational constraints. The configuration of constraints is given, which contains the complexity level 1ₖ∈{1, . . . . L} of each client k and the target computational overhead reduction ratio for each level n. As used herein, the computational overhead and/or the target computational overhead can be based on, for example, model number of parameters (model size), random access memory (RAM) usage, number of floating-point operations (#FLOPs), latency, power consumption, or the like.

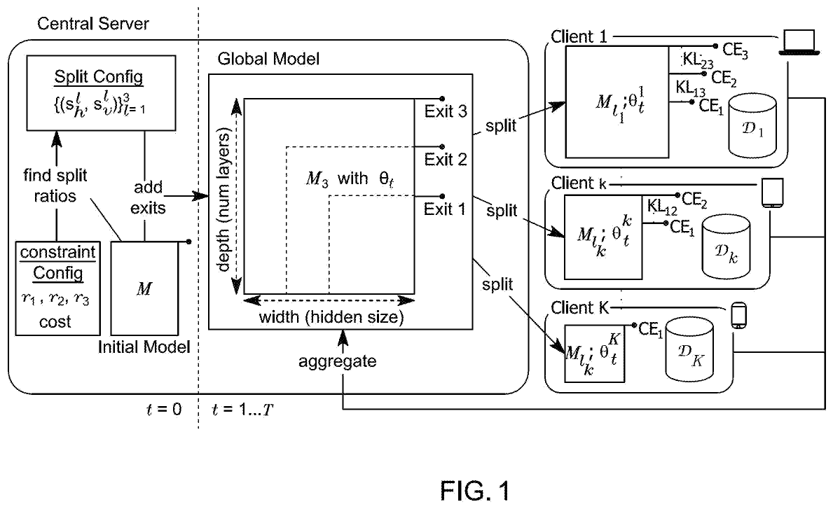

Algorithm 1, below, explains the procedure followed in the present disclosure. The system architecture is provided in FIG. 1 for three levels. Given the constraint configuration for each level j, aspects of the present disclosure can determine the horizontal and vertical split ratios (sₕ^{l}, sᵥ^{l}) using Equation (2), illustrated below, which determines what computed downscaling ratios of the model will be kept for each complexity level along the model's depth and width dimensions respectively. Since the initial model architecture M has only one output in the final layer, early exit classifiers can be injected to the layers based on the computed horizontal split ratio values. This multi-exit model architecture can be denoted as M_{L}, which is considered as the global model in the framework. In FIG. 1, local models can be trained using a combination of cross-entropy (CE) and KL-divergence losses as given in Equation (5), below. Updates can be aggregated back using Equation (1) in the central server for the next round.

Algorithm 1: Framework

```
Inputs: Dataset [symbol]  = {(Xᵢ, yᵢ)}ᵢ₌₁^{N} distributed to K clients with indexes { [symbol] ₖ}ₖ₌₁^{K}, number
of complexity levels L, complexity level of each client {lₖ}ₖ₌₁^{K}, target overhead reduc-
tion ratios for each level {rₗ}ₗ₌₁^{L}, client availability rate s, model architecture M.
Parameters: number of learning rounds T, number of local training epochs E, batch size
B, learning rate η.
Outputs: Trained global model M_{L} with weights θ.
  1:  M_{L} ← M
  2:  for level 1−1, ... L-1 do
  3:  Compute split ratio pair (sₕ^{(l)}, sᵥ^{(l)}) using Equation (2)
  4:  Add early exit classifier to M_{L} at [sᵥ^{(l)}N]-th layer
  5:  end for
  6:  Initialize global model M_{L} with θ₀
  7:  for round t = 0, ... T-1 do
  8:  Sₜ ← random subset of max (1, sK) clients
  9:  for client k ∈ Sₜ in parallel do
10:  Split Mₗ_{ₖ} ← split (M_{L} ; sₕ^{(l}^{ₖ}⁾ , sᵥ^{(l}^{ₖ}⁾)
11:  for epoch e = 1, ... E in client k do
12:  for batch b ⊂ [symbol] ₖ do
13:   $L = \frac{1}{B} {\sum }_{i ∈ b} ℒ ( {M}_{{l}_{k}} ( {X}_{i} ; {θ}_{t}^{k} ) , {y}_{i} ) with Equation ( 5 )$
14:   ${θ}_{t}^{k} ← {θ}_{t}^{k} - η ( \frac{\partial L}{\partial {θ}_{t}^{k}} )$
15:  end for
16:  end for
17:  end for
18:  Aggregate [symbol] , and obtain θₜ₊₁ using Equation (1)
19:  end for
20:  return M_{L} with θ_{T}
```

At each communication round t, a set of available clients Sₜ are sampled and the global model M_{L} with weights θₜ is scaled down to local models with architecture Mₗ_{ₖ} and weights θₜ^{k} for each client k∈Sₜ based on their complexity level 1ₖ. This procedure is detailed in Algorithm 2, below. In this operation, the layers after the corresponding exit at the └sₕ^{(l}^{ₖ}⁾N┘-th layer are removed. Here, index function takes a tensor size “size (W)” and split ratio value sᵥ^{(l}^{ₖ}⁾ as inputs and returns the Boolean index tensor Z, which is used to split weights. In general, for hidden layers, this operation results in accessing the first └sᵥ^{(l}^{ₖ}⁾ [symbol] ᵢ┘ elements of the tensor W (in a hidden layer) along every dimension with size [symbol] ᵢ.

Algorithm 2: Split

| Inputs: Model M with weights θ and N layers | |
|---|---|
| Parameters: Split ratio pair (sₕ, sᵥ) | |
| Outputs: Split model M' with weights θ' | |
| 1: | M' ← M, θ' ← θ |
| 2: | Remove all layers in M' after └sₕ N┘-th layer |
| 3: | for W ∈ θ' do |
| 4: | Z ← index(size(W, sᵥ)) |
| 5: | W ←W[Z] |
| 6: | end for |
| 7: | return M' with θ' |

After receiving the local model, each client performs training for E epochs by minimizing the loss L with self-distillation defined in Equation (5) on its local dataset and sends back the updated weights. In the conventional federated learning model, FedAVG, all models are assumed to have the same architecture, hence aggregation is directly done by averaging. In the present disclosure, the aggregation procedure can be described as follows for every W∈θₜ:

$$W [ {Z}_{l} - {Z}_{l - 1} ] ← \frac{1}{\vert {s}_{t}^{l} \vert} {\sum }_{k ∈ {s}_{t}^{l}} {\overline{W}}_{k} [ {Z}_{l} - {Z}_{l - 1} ] \qquad ( 1 )$$

for 1∈{1, . . . . L}, where Sₜ^{l}={k|k∈Sₜ, 1ₖ≥1}. Here, Z₁=index(size(W), sᵥ^{l}) for 1∈{1′, . . . . L} and 0 for 1<1′, where 1′ is the minimum level that W exists (e.g., 1′=L if W is after (L−1)-th exit). Lastly, W̅ₖ is the zero padded local weight Wₖ such that W̅ₖ[Z₁]=Wₖ and W̅ₖ[1−Z₁]=0. In other words, overlapping weights are aggregated after being scaled by the number of contributing clients.

### Split Configuration

In this section, it is explained how the split ratios used to downscale the global into local models is computed at each complexity level. Let C=overhead(M) denote the computational overhead of the initial model M. For a given target computational overhead reduction ratio r₁ for the complexity level 1∈{1, . . . . L−1}, it can be determined at what ratio of the model to keep at each level horizontally and vertically (sₕ^{(l)}, sᵥ^{(l)}) as follows:

$$( {s}_{h}^{( l )} , {s}_{v}^{( l )} ) = arg {min}_{( {s}_{h}^{′} , {s}_{v}^{′} )} \vert ( {s}_{h}^{′} - {s}_{v}^{′} ) \vert such that \\ \vert \frac{cost ( split ( {M}_{L} ; ( {s}_{h}^{′} , {s}_{v}^{′} ) )}{{r}_{l} C} - 1 \vert \leq ϵ \qquad ( 2 )$$

In other words, the most uniform split ratio pair can be found that satisfies the target computational overhead through a grid search within the window defined by ϵ. For the highest complexity level, sₕ^{{L}}=sᵥ^{(L)}=1 is considered, i.e., local models at level L are the same as the global model during training. The overhead function can be defined by the user depending on the computational constraints of the application scenario. Two cases are considered in the present disclosure, (1) a spatial constraint: overhead(M)=#PARAM S(M) is the number of parameters in the model; and (2) a temporal constraint: overhead(M)=#FLOPs(M) is the number of floating point operations (FLOPs) in one forward pass of the model.

Optimization with Self-Distillation

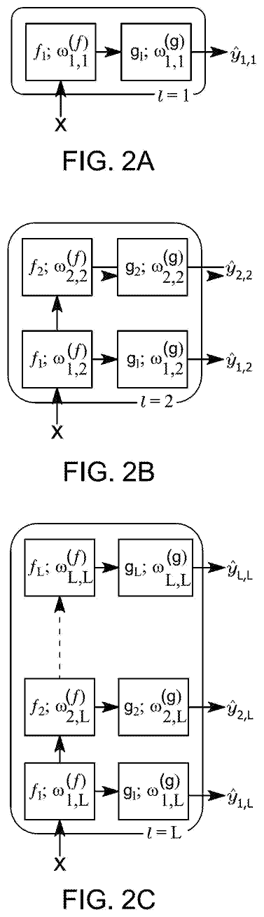

The subnetworks of the global model M_{L} can be denoted as illustrated in FIG. 2, where subnetwork structures for local models at levels 1, 2 and L as shown. For the local model Mⱼ at level j, fᵢ is the i-th core subnetwork with weights ω_{i,j}^{(f)}. Likewise, gi is the i-th exit classifier subnetwork with weights ω_{i,j}^{(g)} is the output at the i-th exit of Mⱼ. The forward pass of local models can be formulated as follows:

$${H}_{i , j} = {f}_{i} ( {H}_{i - 1 , j} ; {ω}_{i , j}^{( f )} ) , \qquad ( 3 )$$

$${\hat{y}}_{i , j} = {g}_{i} ( {H}_{i , j} ; {ω}_{i , j}^{( g )} ) . \qquad ( 4 )$$

for 1≤i≤j≤L where j is the level of the local model and H_{0,j}=X. After obtaining the prediction logits at each exit for M₁ at level 1, the loss with self-distillation is calculated as follows:

$$ℒ = \frac{1}{l ( l + 1 )} {\sum }_{i = 1}^{l} i ( {βℒ}_{KL} ( {\hat{y}}_{i , l} , {\hat{y}}_{l , l} ; τ ) + {ℒ}_{CE} ( {\hat{y}}_{i , l} , y ) ) \qquad ( 5 )$$

where [symbol] _{KL}(ŷₛ·ŷₗ; τ)=sum (σ(ŷₜ/τ) log ((σ(ŷₜ/τ)/σ(ŷₛ/τ))τ²) is Kullback-Leibler divergence with temperature τ>0, [symbol] _{CE}(ŷ, y)=−log σ(ŷ) [y] is cross-entropy loss for target class y, σ is softmax function and β∈[0, 1) is the hyperparameter that controls the self-distillation effect.

### Inference

Finally, the pseudo-code is provided for inferencing in Algorithm 3, below. Based on the complexity level of the client 1, global model M_{L} is split and inference is performed on the local model M₁. If an adaptive inference flag a is enabled, this procedure also continuously outputs early exit predictions.

Algorithm 3: Inference

```
Inputs: Global model M_{L}, test input X, complexity level of the client for inference 1,
$split ratio pairs {\{ ( {s}_{h}^{( {l}^{′} )} , {s}_{v}^{( {l}^{′} )} ) \}}_{{l}^{′} = 1}^{L} , adaptive inference flag a ∈ \{ 0 , 1 \}$
Outputs: prediction ŷ
  1: Split: Mₗ ← split(M_{L} ; sₕ^{(l)}, sᵥ^{(l)})
  2: for l’ ∈ {1, . . . , 1} do
  3: Calculate H_{1’1} using Equation (3)
  4: if a and l’ ≠ 1 then
  5: Calculate ŷ_{1’1} using Equation (4)
  6: yield ŷ_{1’1}
  7: end if
  8: end for
  9: Calculate ŷₗₗ using Equation (4)
10: return ŷₗₗ
```

### Example Process

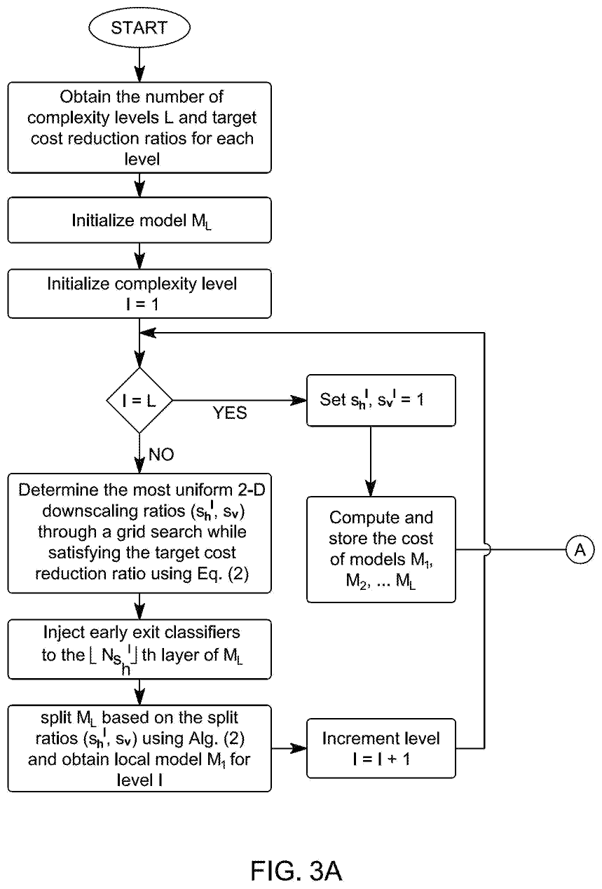

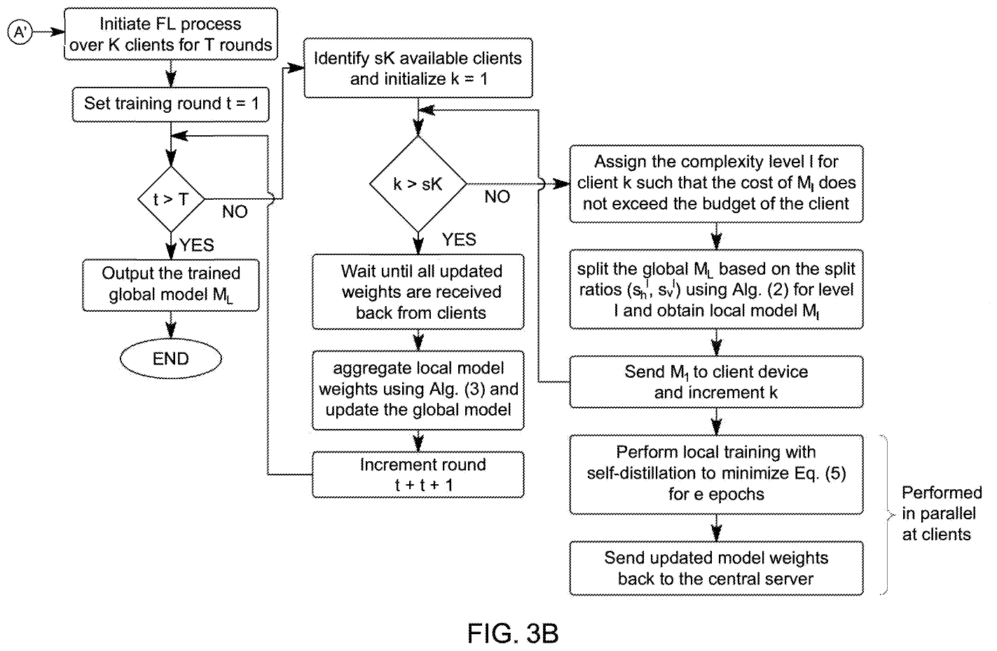

It may be helpful now to consider a high-level discussion of an example process. To that end, FIGS. 3A and 3B present an illustrative process 300 related to the method for training deep neural networks in a federated learning system. Process 300 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIGS. 3A and 3B, a process 300 for training deep neural networks in a federated learning system starts at block 302 where the system can obtain the number of complexity levels L and target overhead reduction ratios for each level. At block 304, a model M_{L} is initialized with, at block 306, an initialized complexity level 1=1. If 1 is not equal to L, then, at block 308, the process can determine the most uniform 2-dimensional downscaling ratios (sₕ^{l}, Sᵥ) through a grid search while satisfying the target overhead reduction ratio using Equation (2). At block 310, early exit classifiers are injected into the └Nsₕ^{l}┘-th layer of M_{L}. At block 312, M_{L} is split based on the split ratios (sₕ^{l}, Sᵥ) using Algorithm 2 to obtain a local model M₁ for level 1. The increment level 1 can be increased by one at block 314 and the process can again determine whether 1=L. If 1 is not equal to L, then blocks 308 through 314 are repeated.

Once 1=L, the process continues to block 316, where sₕ^{l} and sᵥ^{l} are set to 1. At block 318, the computational overheads of models M₁, M₂, . . . . M_{L} are computed and stored. At block 320, the federated learning process is initiated over K clients for T rounds. The training round t is set to 1 at block 322. If t>T, then the output of the trained global model M_{L} is output at block 324.

If t is not greater than T, then, at block 326, sK available clients are identified and k is initialized to 1. If k is not greater than sK, then, at block 328, the complexity level 1 is assigned for client k such that the overhead of M₁ does not exceed the budget of the client. At block 330, the global model M₁ is split based on the split ratios (sₕ^{l}, Sᵥ^{l}) using Algorithm 2 for level 1 and the local model M₁ can be obtained. The local model M₁ can be sent to the client device and k is incremented by one at block 332. The process can return to comparison block 338 to check to determine if k is greater than sK. If k is not greater than sK, then blocks 328 through 332 are repeated.

Once k is greater than sK, then, at block 340, the process can wait until all updated weights are received back from the clients. At block 342, then local model weights are aggregated using Algorithm 3 and the global model ML is updated. At block 344, the training round t is incremented by one and the process continues back to decision block 346.

At block 334, local training can be performed with self-distillation to minimize Equation (5) for e epochs. At block 336, updated model weights can be sent back to the central server. It should be noted that blocks 334 and 336 can be performed in parallel at all K clients.

### Results

The datasets CIFAR-10 and CIFAR-100 (Canadian Institute For Advanced Research) were used, where each dataset has train size of 50,000 images, a test size of 10,000 images, a resolution of 32 and a number of classes of either 10 (CIFAR-10) or 100 (CIFAR-100). The system topology includes 100 clients with 10% availability at each round and four complexity levels with target overhead reduction ratios of 12.5%, 25%, 50%, 100%, where the client level distribution is uniform (each level contains 25% of the clients).

Data was obtained comparing top-1 accuracy to either inference time per sample or number of parameters for the process of the present disclosure and conventional federated learning baselines, including FedAVG, which is a level-1 subnetwork trained using federated averaging algorithm and Decoupled, where one model for each complexity level is trained in a decoupled way. Further, existing methods, such as HeteroFL, which employs vertical model splitting along width, and FedDF, which uses ensemble distillation on central server over an additional dataset after each round, are compared to the process of the present disclosure.

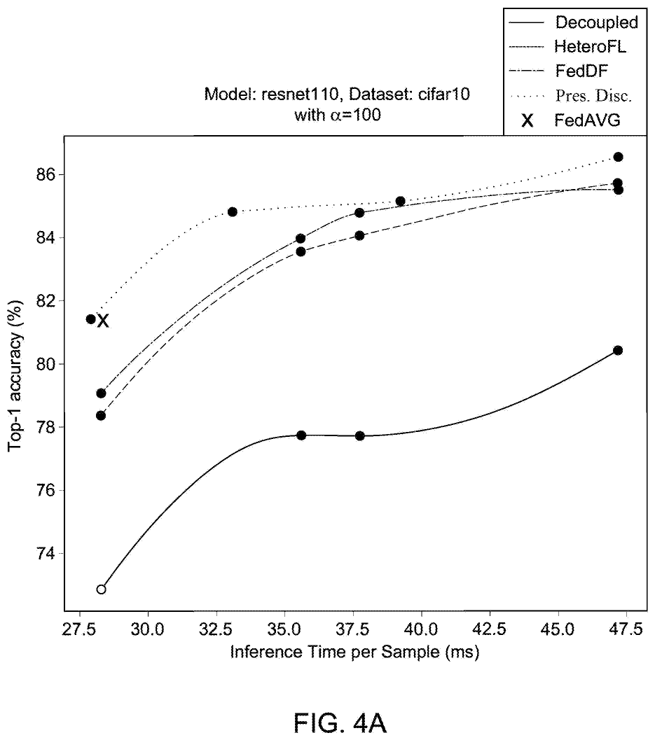

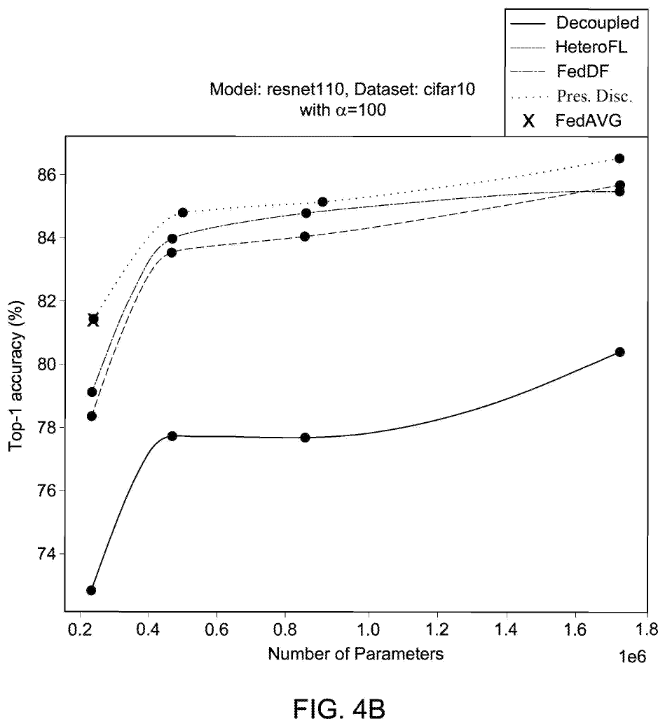

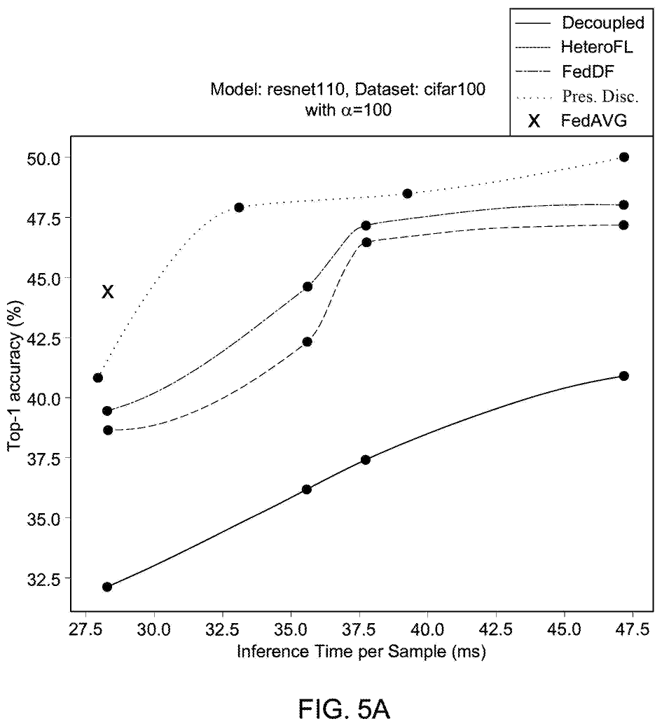

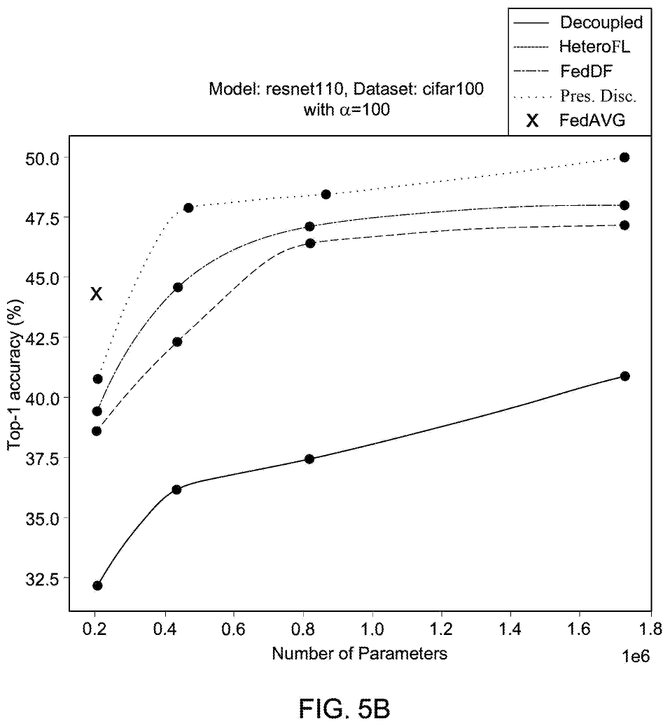

FIGS. 4A and 4B illustrates the inference time per sample and number of parameters, respectively, for the conventional process as compared to the process of the present disclosure, on CIFAR-10. FIGS. 5A and 5B illustrates the inference time per sample and number of parameters, respectively, for the conventional process as compared to the process of the present disclosure, on CIFAR-100. In the results, it can be seen how the process of the present disclosure (labeled as “Pres. Disc.”) provides the highest accuracy at each inference time per sample measured as well as the best accuracy at each measured number of parameters.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

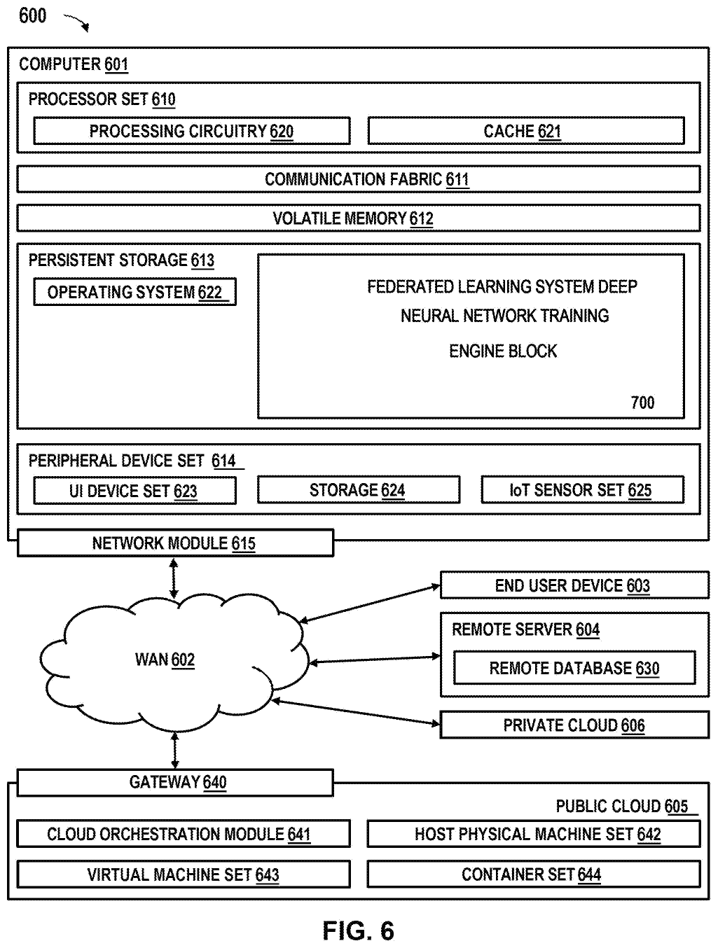

Referring to FIG. 6, computing environment 600 includes an example of an environment for the execution of at least some of the computer code involved in performing the inventive methods, including a federated learning system deep neural network training engine block 700. In addition to block 700, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 700, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 700 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 700 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for training a global model on a central server in a federated learning system having a plurality of nodes, the method comprising:
splitting the global model along a width and a depth via two-dimensional uniform downscaling of the global model;
creating a plurality of local models based on the splitting of the global model; and
training selected ones of the plurality of local models on respective selected ones of a plurality of clients based on computational constraints of each of the plurality of clients.

2. The computer-implemented method of claim 1, further comprising, receiving, at the central server, local model parameters from each of the plurality of clients.

3. The computer-implemented method of claim 2, further comprising:
aggregating, at the central server, the local model parameters across the plurality of clients into global model parameters; and
sending the global model parameters to each of the plurality of clients to update respective local models at each of the plurality of clients.

4. The computer-implemented method of claim 3, further comprising:
waiting, by the central server, until the aggregated local model parameters are received from all of the plurality of clients before updating the global model parameters.

5. The computer-implemented method of claim 1, further comprising:
obtaining a number of complexity levels for the federated learning system;
obtaining a target computational overhead reduction ratio for each of the complexity levels; and
computing a computational overhead of each of the plurality of local models at each of the complexity levels.

6. The computer-implemented method of claim 5, further comprising determining early exits of the global model to generate a local model for each of the complexity levels.

7. The computer-implemented method of claim 1, further comprising determining a uniform two-dimensional downscaling ratio through a grid search.

8. The computer-implemented method of claim 1, further comprising initiating, by the central server, a federated learning round t for t=1, 2, . . . , T.

9. The computer-implemented method of claim 8, wherein the central server ends the training after T rounds and outputs a trained global model.

10. The computer-implemented method of claim 1, further comprising identifying, by the central server, sK available clients among the plurality of clients.

11. The computer-implemented method of claim 10, further comprising sending, by the central server, a selected one of the plurality of the local models to each of the sK available clients.

12. The computer-implemented method of claim 11, further comprising:
assigning a complexity level for each of the sK available clients such that a computational overhead of an assigned local model for each of the sK available clients does not exceed a budget of each of the sK available clients;
obtaining the assigned local model by applying a split algorithm to the global model with computed downscaling ratios for each complexity level; and
sending the assigned local model to a client device.

13. The computer-implemented method of claim 1, further comprising training each of the plurality of local models on each of the plurality of clients in parallel.

14. A computer-implemented method for training a global model on a central server in a federated learning system having a plurality of nodes, the method comprising:
obtaining a number of complexity levels for the federated learning system;
obtaining a target computational overhead reduction ratio for each of the complexity levels;
splitting the global model along a width and a depth via two-dimensional uniform downscaling of the global model to create a plurality of local models, wherein one of the plurality of local models corresponds to each of the number of complexity levels;
computing a computational overhead of each of a plurality of local models at each of the complexity levels;
sending an assigned one of the plurality of local models to each of a plurality of clients based on an available computational overhead budget at each of the plurality of clients, wherein the computational overhead of the assigned one is less than the available computational overhead budget at each of the plurality of clients; and
training the assigned ones of the plurality of local models on respective ones of the plurality of clients.

15. The computer-implemented method of claim 14, further comprising receiving, at the central server, local model parameters from each of the plurality of clients, the local model parameters generated during the training.

16. The computer-implemented method of claim 15, further comprising:
aggregating, at the central server, the local model parameters across the plurality of clients into global model parameters; and
sending the global model parameters to each of the plurality of clients to update respective local models at each of the plurality of clients.

17. The computer-implemented method of claim 14, further comprising training each of the plurality of local models on each of the plurality of clients in parallel.

18. A non-transitory computer readable storage medium tangibly embodying a computer readable program code having computer readable instructions that, when executed, causes a computer device to carry out a method of training a global model on a central server in a federated learning system having a plurality of nodes, the method comprising:
splitting the global model along a width and a depth via two-dimensional uniform downscaling of the global model;
creating a plurality of local models based on the splitting of the global model; and
training selected ones of the plurality of local models on respective selected ones of a plurality of clients based on computational constraints of each of the plurality of clients.

19. The non-transitory computer readable storage medium of claim 18, the method further comprising:
receiving, at the central server, local model parameters from each of the plurality of clients;
aggregating, at the central server, the local model parameters across the plurality of clients into global model parameters; and
sending the global model parameters to each of the plurality of clients to update respective local models at each of the plurality of clients.

20. The non-transitory computer readable storage medium of claim 18, the method further comprising:
obtaining a number of complexity levels for the federated learning system;
obtaining a target computational overhead reduction ratio for each of the complexity levels; and
computing a computational overhead of each of the plurality of local models at each of the complexity levels.
